(19) United States
(12) Patent Application Publication
(10) Pub. No.: US 2004/0022990 A1
(43) Pub. Date: Feb. 5, 2004

(54) Compositions and methods for providing extended release of fragrances and other agents

(76) Inventor: Arif Sitabkhan, Westlake, OH (US)

Correspondence Address: David A. Casimir, MEDLEN & CARROLL, LLP, 101 Howard Street, Suite 350, San Francisco, CA, 94105, US

(21) Appl. No.: 10/406,535

(22) Filed: Apr. 3, 2003

Related U.S. Application Data
(60) Provisional application No. 60/369,799, filed on Apr. 3, 2002.

(51) Int. Cl. B32B 17/02

(52) U.S. Cl. 428/85; 428/402.2

(57) ABSTRACT

The present invention relates to compositions and methods for providing extended release of fragrances and other agents into a variety of materials, including carpets, rugs, fibrous mats, furniture, drapery, and similar products and materials.

The present application claims priority to U.S. Provisional Patent Appln. No. 60/369,799, filed Apr. 3, 2002, which is hereby incorporated by reference in its entirety.

### FIELD OF THE INVENTION

The present invention relates to compositions and methods for providing extended release of fragrances and other agents into a variety of materials, including carpets, rugs, fibrous mats, furniture, drapery, paper, and similar products and materials.

### BACKGROUND

Techniques for the introduction of a fresh fragrance or pleasant scent into a room are usually active in the sense that they require an action by an individual to initiate the freshness (e.g., aerosol and trigger sprays), or they must be activated through electric current (plug-ins and ionizers), lit (candles), or opened (sachets and gel accessories). These active techniques have inherent disadvantages. Specifically, they are relatively short-lived, with effective lifetimes measured in hours for sprays and candles, and/or weeks for the plug-ins. They also do not address the origins of the odors, but merely mask the odor until such fragrance becomes inactive or ineffective.

It is well understood that rooms or environments that are carpeted, or which possess a high amount of fabric in the form of drapery or porous and textured wallpaper not only collect, absorb, and adsorb malodorous chemical components, but they also provide a nutrient rich environment for odor producing bacteria and organisms to grow.

Although there are available techniques and methods for protection of a rug or carpet against bacteria and micro-organisms that produce mildew and odors, such as treatment at the mill with organo-tin and arsenic compounds, bis-chlorinated phenols, or the use of quaternary ammonium sulfonamide derivatives and other quaternary ammonium compounds, these methods are either toxic after long term exposure or are not sufficiently durable to merit expanded commercial use. However, the recent development of processes in which biologically active molecules are bonded to surfaces via the use of silicone quaternary amines with broad spectrum anti-microbial ingredients has essentially solved the issue of long term protection of rugs against micro-organisms which are continually cleaned (shampooing and vacuuming). These products, such as SYLGARD Anti-microbial Treatment (Dow Coming) are effective, yet they require professional installation by trained installers and technicians.

Other attempts to address this problem include U.S. Pat. No. 6,233,776 to Blum et al., which discloses a non-slip plastic and/or rubber floor mat that is self-cleaning, and contains a fragrance and an anti-microbial component. However, both components are incorporated into the plastic.

U.S. Pat. No. 5,156,843 to Leong et al., which is incorporated herein by reference in its entirety. The mechanism of the technology in this patent relies on the diffusion of the active agent through selective structural pores created upon the synthesis of special capsules. These capsules are solid, semi-rigid structures composed of cross-linked copolymers of styrene, di-vinyl-benzene, methyl methacrylate, ethylene glycol di-methyl-methacrylate, and also ethylene, propylene-dicyclo-pentadiene.

U.S. Pat. No. 6,046,243 to Wellinghoff et al., which is incorporated herein by reference in its entirety, provides an exhaustive and rigorous description of a gaseous anti-microbial composite which contains highly active components to only deodorize carpets and rugs.

The art remains in need of easy to use, long-lasting compositions and methods for imparting fragrances and other desired components into fabrics and related materials.

### SUMMARY OF THE INVENTION

The present invention relates to compositions and methods for providing extended release of fragrances and other agents into a variety of materials, including carpets, rugs, fibrous mats, furniture, drapery, paper, and similar products and materials.

For example, the present invention provides an extended release fragrance composition comprising a fragrance, an anti-microbial agent and an odor-neutralizing component. In some embodiments, one or more of said fragrance, said anti-microbial agent, and said odor-neutralizing component is contained in a micro-capsule. In some preferred embodiments, the micro-capsule is composed of a poly-oxymethylene cross-linked structure. In some preferred embodiments, the micro-capsule is configured to rupture upon exposure to compression force, heat, or shear force.

In some preferred embodiments, the composition further comprises a binding agent configured to bind the micro-capsule to a material (e.g., fabric, paper, or any other material described herein).

The present invention further provides an extended release fragrance composition comprising a micro-capsule containing a fragrance, wherein said micro-capsule is configured to rupture upon exposure to compression force, heat, or shear force. In some embodiments, the composition further comprises an anti-microbial agent. In some embodiments, the composition further comprises a binding agent configured to bind the micro-capsule to a material. In some embodiments, the composition further comprises an odor neutralizing component.

The present invention also provides materials bound by the micro-capsules and/or formulations of the present invention. In some preferred embodiments, the materials comprise fabric materials (e.g., carpet or any other fabric material described herein). In other embodiments, the material comprises a material use for arts and crafts (e.g., paper, synthetic flowers, or any other material described herein).

The present invention also provides methods of treating materials (e.g., fabric, paper, etc.) with any of the formulations or compositions described herein. In some embodiments the method comprises the step of exposing the material to the composition under conditions such that said composition binds to the material.

The present invention further provides methods of manufacturing the formulations and compositions described herein.

### GENERAL DESCRIPTION OF THE INVENTION

This present invention relates to the treatment of consumer and industrial products, including, but not limited to, paper, carpets, rugs, fibrous mats, furniture, drapery, and/or other items of woven fabric that can incorporate poly urea-formaldehyde micro-capsules into their porous structures, said structures being of a composition suitable for providing continued freshness. The size and composition of these micro-capsules preferably allow for the slow and continued release of a fragrance and/or an anti-microbial component over time, yet are allowed to rupture under the action of shear or compression allowing for an immediate pleasant sensation of scent or fragrance. It is through this mechanism that carpets, rugs, woven mats, and other items of woven fabric not only maintain freshness, but also become a unique passive delivery device for continual room and area freshening.

It has been demonstrated, through the use of spray-on chemical formulations that are applied to the surfaces of these items, that freshness can be maintained for not only extended periods of time, but more importantly can be activated by an individual at the time of use by the unintended actions of an individual within the room or environment. Such actions by an individual include crushing and releasing under the actions of ordinary foot traffic or through other means of shear and rupture.

### DETAILED DESCRIPTION OF THE INVENTION

The present invention provides anti-microbial activity, odor suppression and fragrance preferably through micro-encapsulation. Certain exemplary embodiments are described below to illustrate the present invention. The present invention is not limited to these particular embodiments.

In preferred embodiments of the present invention, the effectiveness of the invention is due to a urea-formaldehyde copolymer that sufficiently breaks down over time to release trace quantities of the formaldehyde preservative. In preferred embodiments, the form of the present invention is a simple, safe, solvent-based (e.g., water or alcohol-based) chemical formulation that can be applied at any time by a consumer without special training. The passive nature of this technique of room or area freshening precludes the need for continual treatments and applications of deodorizers, sanitizers, fragrances, and other treatments that aid in the maintenance of freshness.

The active agents of the formulation can be designed to accommodate and remove specific odors allowing immediate customization of each formula to an application. In addition, the urea-formaldehyde based micro-capsules utilized in preferred embodiments of the present invention are a self contained sphere generally ranging in diameter from 1-100 microns (although other sizes may be generated as desired). These spheres preferably do not contain pores from which contents are stored, transported and released. Release of the contents is accomplished through membrane diffusion or more specifically through rupture, shear, pressure, or increases in temperature.

The present invention relates to the delivery of agents to all types of fabric substrates and related materials over an extended period of time. The agents are preferably placed into a micro-capsule, which ruptures or breaks due to compression, heat, shear, or stress. Preferably, the micro-capsules contain fragrances, anti-microbial agents, and odor neutralizing components in combination. In alternative embodiments of the present invention, fragrances, anti-microbial agents, and odor neutralizing components may be placed individually into a micro-capsule.

The primary functional ingredients of the formulation are delivered to the substrate through the use of a carrier solvent or media. Preferably, the ingredients in the free solution and in combination with the micro-spheres are simply sprayed onto the surface of the target substrate and attached to the surface through the use of chemical binders. In this manner, the free form of the functional ingredients, as well as the encapsulated form are delivered to the surface of the fabric substrate. It is the encapsulated form that provides efficacy and release at any future time during the service life of the capsules. Although the transmigration of the ingredients can be very slow through the membrane, the present invention has particular utility in areas where active ingredients are released through compression, heat, shear, or stress. Preferably, the use of a binder system to attach and anchor the capsules to the substrate aids in the long-term efficacy of the product, especially as the micro-capsules may otherwise be removed through vacuuming of the carpets and rugs. The preferred use of a binder will allow areas that contain the micro-capsules, such as a room or carpet surface, to smell fresh and clean.

In one embodiment, the present invention provides a composition comprising the micro-capsules alone (e.g., containing or associated with fragrances, odor suppressors, anti-microbial agents, binders, etc.), in a delivery system (e.g., packaging, spray container, etc.), or in contact with target materials. In other embodiments, the present invention provides for methods of treating surfaces with micro-encapsulated formulations that allows for the release of agents upon compression, heat, shear, or stress. In yet another embodiment, the present invention provides methods of preparing a micro-encapsulated formulations that, upon compression, heat, shear, or stress, releases the agents contained within the micro-capsule.

In one embodiment of the present invention, a micro-encapsulated formulation, when applied to a rug, carpet or woven fabric of suitable nature, not only maintains the freshness of the area in which the item resides, but allows that item to become a delivery device for a pleasant and refreshing scent or fragrance. More significantly the passive nature of this technology allows an individual to immediately experience a fresh sensory experience without the application of a room freshener immediately prior. Preferably, the formulation described in this invention comprises a water-based composition of solid phase microcapsules, a binder, and water. The encapsulated ingredients release the active contents upon compression, shear, heat, or through any other physical and mechanical stresses.

Preferably, the composition used to achieve maintenance and introduction of freshness into areas includes fragrance, an anti-microbial agent and odor neutralizing components over an extended period of time. These materials may or may not be contained within a micro-capsule in the formulation. Also the micro-capsules preferably include a sufficient binder and water-based carrier system to deliver and attach the subject micro-capsules to any fabric surface. The carrier system is either hydrophilic or hydrophobic in nature. The hydrophobic carrier can consist of, but is not limited to, a mineral spirit based hydrocarbon. The hydrophilic carrier can consist of, but is not limited to, water.

The micro-capsules used in preferred formulations are manufactured from the polymerization reaction of urea and formaldehyde to form a poly-oxymethylene cross-linked structure. Then through simple coacervation processes, the micro-capsules are processed into spherical beads of approximately 1-100 microns in diameter. In the preferred embodiment of this invention, the size of the capsules range from 5-20 microns in diameter. These micro-capsules or beads encapsulate the hydrophobic liquid or solid of choice. In the preferred embodiment of this invention, micro-capsules of this type are supplied by Lipo Technologies Inc, of Dayton, Ohio.

In a preferred embodiment of the present invention, encapsulation of one or a combination of a number of potential active hydrophobic ingredients, upon rupture or breakage, releases a fragrance, an odor neutralizer, and an anti-bacterial component. In one embodiment, an anti-microbial agent alone is contained in a microcapsule. The anti-microbial agent can be used alone in a micro-capsule, or preferably, in combination with odor neutralizing components and fragrance. In a preferred embodiment, the anti-microbial compound is 2,4,4′-Trichloro-2′-hydroxydiphenyl ether, i.e., Triclosan. Triclosan is a broad spectrum antibacterial/antimicrobial agent manufactured in the U.S. by Ciba Specialty Chemicals under the trade name of Igasan DP300, as well as by several manufacturers outside of the U.S. The anti-microbial is contained within a micro-capsule. Any anti-microbial compound, compounds, or formulations may be used with the present invention. Exemplary materials are described in U.S. Pat. No. 5,672,351 and the text “Handbook of Topical Antimicrobials: Industrial Applications in Consumer Products and Pharmaceuticals” eds. Paulson, Paulson, and Little (2002), herein incorporated by reference in their entireties.

In one embodiment, an odor-neutralizing component is contained in a micro-capsule. The odor neutralizing component alone can be used in the micro-capsule, or preferably, the odor neutralizing component is used in combination with an anti-microbial agent and fragrance. Any odor-neutralizing material may be used with the present invention. In preferred embodiments, the odor-neutralizer is a mixture of organic cyclo-ethers referred in the trade as OdorSynthesis. OdorSynthesis is a trademark of the Shaw Mudge & Company of Shelton, Conn. The odor neutralizer may or may not be encapsulated, however in a preferred embodiment of the present invention, the odor neutralizer component is made into a water-soluble form and placed in the free solution, as well as encapsulated in the formulation. In this manner, odor removal is not only possible upon immediate application of the product, but is also available through slow release or upon sudden release when the capsules are broken or crushed by walking over the surface of a rug or carpet, or any of the previously described fabrics. Therefore, in a preferred embodiment, the odor neutralizer is contained in a microcapsule. In preferred embodiments, the neutralizing agent is selected from a group of hydrophobic and hydrophilic mixtures of organic cyclo-ethers.

In another embodiment, a fragrance is contained in a microcapsule. The fragrance can be used alone in a micro-capsule, or preferably, the fragrance is used in combination with an anti-microbial agent and odor neutralizing components. Fragrances chosen for encapsulation are of the types that possess preferably higher vapor pressure top-notes of herbal, and/or light floral components and comprising, but not limited to, low molecular weight aldehydes, ketones, and terpenes. The fragrance is selected from, but is not limited to, the group of mono-cyclic and allylic terpenes, lanones, damascones, poly-cyclic aromatic phenols, macro-cyclic phenols and esters, saturated and unsaturated esters, lactones, and substituted phenolics, macro-cyclic lactones and poly-cyclic, and poly-substituted compounds. Higher vapor pressure or top-note fragrances are preferred for immediate sensory recognition by the observer, especially for carpet applications. Fragrance types most preferred for this application are those that contain, but are not limited to, bergamot, lavender, jasmine, hyacinth, rose, and herbal. As in the above example, the fragrance component may or may not be encapsulated, however in a preferred embodiment of this invention, the fragrance component is encapsulated. Also, in a preferred embodiment, the fragrance is hydrophobic. Fragrances that may be used with the present invention are described in U.S. Pat. No. 6,426,325, herein incorporated by reference in its entirety, and are available from companies, including, but not limited to, Custom Essence (Somerset, N.J.), Belle Air Fragrances (Mundelein, Ill.), IFF, International Flavors and Fragrances (New York, N.Y.), and Shaw Mudge (Shelton, Conn.).

Fragrance may be applied to material to provide seasonal scents, topical scents, or scents that correspond to the object that is treated. Examples of such uses are shown in Table 1, below.

TABLE 1

| | Fragrance 1 | Fragrance 2 | Fragrance 3 | Fragrance 4 | Fragrance 5 |
|---|---|---|---|---|---|
| Holiday | | | | | |
| Christmas | Blue Spruce | Xmas Spice | Yule Log | Candy Cane | Xmas Cookie |
| Halloween | Cornucopia | Pumpkin Pie | Harvest | | |
| Valentines Day | Romantic | Pink | Sweet tarts | Roses | Chocolate |
| Easter/Passover | Lily | Spring Flowers | New Foliage | Chocolate | |
| July 4th | Apple Pie | Summer Breeze | Field Flowers | Spicy Apple Pie | Watermelon |
| Thanksgiving | Cornucopia | Harvest | Pumpkin Pie | Spicy Apple Pie | |
| St. Patrick's Day | Shamrock | Forest Mist | Foliage | Irish Coffee | |
| Season | | | | | |
| Winter | Winter Pine | Blue Spruce | Snowflake | Peppermint | Frosted Spruce |
| Spring | Spring Bqt | Daffodil | Forest mist | | |
| Summer | Field Flowers | Dry Grass | Watermelon | | |
| Fall | Autumn Leaves | Harvest | Cornucopia | Spicy Apple Pie | |
| Special Occasions | | | | | |
| Beach Parties | Beach | Cool Water | Aqua | | |
| Weddings | Floral Bouquet | White Flowers | Rose | Calla Lily | |
| Wedding Showers | Floral Bouquet | White Flowers | Rose | Calla Lily | |
| Baby Showers | Powder | Powder Floral | | | |
| Graduation | Energizing | Unisex Fresh | Celebration | | |
| Birthday | Cake | Unisex Fresh | Celebration | | |
| Specific Usages | | | | | |
| Artificial Flowers | Floral Bqt | Silk Floral | | | |
| Wrapping Paper | Celebration | Unisex Fresh | | | |
| X-mas Wrapping Paper | Celebration | Unisex Fresh | | | |
| Ribbons and ties | Celebration | Unisex Fresh | | | |
| Costumes | Celebration | Unisex Fresh | | | |
| Clothes/Fabrics | April Fresh | Sun Dried Linen | | | |
| | | Snuggles | | | |
| Vinyl | Unisex Fresh | Musk | Floriental | | |
| Construction Paper | Unisex Fresh | Musk | Floriental | | |
| Gag Gifts | Unisex Fresh | Musk | Floriental | | |
| Misc. School Projects | Unisex Fresh | Musk | Floriental | | |

As can be seen in Table 1, the present invention contemplates the use of the scented compositions in products made of fabric-like or paper materials to impart a desired scent. Such applications include, but are not limited to the following:

1. Artificial Flower Fragrancing—Adding a temporary scent to artificial flowers. Thus every time one gets close or ruffles the petals an appropriate scent is noticed.

2. Seasonal artificial flowers

3. Fake fruits and vegetables fragrancing

4. Wrapping paper for seasonal and events

5. Ribbons for seasonal and events

6. Costumes

7. T-shirt making

8. Latch Hook, Cross Stitch

9. Wood crafts

10. Fuzzy posters

11. Dolls (hair, clothes, etc.)

12. Embroidery

13. Construction paper

14. Table cloths (seasonal fragrances)

15. Wall paper

16. Cards, decorations, etc.

As should be clear from these examples, the compositions and methods of the present invention can be applied to any appropriate application now known, or later developed.

The formulations of the present invention may vary depending on the specific application. There are two general types of products: (1) a time release fragrance and odor neutralizer/anti-bacterial for carpeting and other non-wovens, and (2) arts and crafts. Table 2, below lists some exemplary, non-limiting ways that the formulations are packaged and delivered for each of these general areas.

TABLE 2

| Product | Delivery Systems | Micro-encapsulation form |
|---|---|---|
| Arts & Crafts | Aerosol | Powder, Slurry (30% |
| | | solids), Cake (90% |
| | | capsules, 10% water) |
| Carpeting, non-wovens | Aerosol, Pump | Powder, Cake, Slurry |
| | sprayer, Triggers | |
| | Sprayer, Powder | |
| | that is sprinkled | |
| | onto the carpet | |

In some embodiments, the micro-encapsulation chemistry is powder-based rather than a slurry. In some preferred embodiments, manufacture of the micro-particles is done in an emulsion form. A polymer shell then coats the oil micelles, forming the microcapsule. To make a powder form, the composition is spray dried, to evaporate off the remaining water. Thus, the powder version of the microcapsule is the same composition as the slurry, except there is little or no water.

Any available methods may be used in the manufacture of the materials. Exemplary methods are available from the Southwest Research Institute (SwRI) (San Antonio, Tex.) Microencapsulation and Controlled Release program. Modifications can be made to wall thickness using the micro-encapsulation chemistry. A thinner wall allows the capsules to break easier and with less abrasion or physical pressure. Micro-capsule technologies that may be used with the present invention are available from Lipo Technologies (Vandalia, Ohio) and Ronald T. Dodge Co. (Dayton).

The fragrance chemistry can be controlled by altering the volatility and boiling point of the fragrance to produce more or less effusive results. Thus, in applications where it is desired to have the fragrance emanate quickly after perturbation of the micro-capsules, a very volatile or low boiling point fragrance is used. In other applications, it may be desired that the evolution of fragrance emanate over time after it has been touched—thus a high boiling point fragrance is used. In some embodiments, a combination of both is used.

In another preferred embodiment, a binder is added to the liquid water-based formulation for the purpose of allowing the capsules to adhere to the surface on which they are applied. The binder compound in a preferred embodiment is an organic compound, which can comprise poly-vinylacetate/poly vinylpyrollidone, and polysaccarhide resins including, but not limited to, natural and synthetic starches and gums. However, in preferred embodiments, the binder can include, but is not limited to, to any water-soluble materials, such as any synthetic polymer, or any water dispersable binders, such as Gum Arabic and/or water insoluble resins such as polyacrylate/octylacrylamide copolymers. These binders are effective in attaching the capsules to all horizontal, as well as vertical surfaces such as drapery.

In some embodiments, specific levels of active components may appear in the following ranges: Carrier liquid, 78-99%, an appropriate fragrance of such described, 0.01-2%, and odor neutralizer of such described, 0.01-5%, an anti-microbial material of such described, 0.001-0.05%, and a binder system, 0.1-10%.

The present invention provides for a formulation that, when applied, preferably fibrous structures such as carpets, rugs, drapery, and furniture, can maintain the freshness of a variety of areas, such as hotel rooms, spa areas, or locker rooms prior to arrival of a guest or client. The application of the formulation can be as long as month(s) prior to the guest's arrival. In some preferred embodiments, the formulation comprises approximately 2-5% micro-capsules of a composition containing the OdorSynthesis odor neutralizer #47852B and approximately 0.1 to 0.3% of Triclosan and approximately 0.1-0.5% of a binder and is applied to the target surfaces by means of a spray trigger bottle. The misted product then is allowed to dry within the course of 5-15 minutes.

Exemplary formulations are provided in Table 3, below.

TABLE 3

| | | | |
|---|---|---|---|
| | Preferred | Exemplary | Exemplary |
| General | Concentration | Ranges | Chemicals |
| Chemical | (by weight) | (by weight) | to be used |

Arts and Crafts Applications

| | | | |
|---|---|---|---|
| Water | 0% | 0%-99% | Deionized water, |
| | | | tap water |
| Solvent | 28% | 0%-99% | n-propanol, |
| | | | ethanol, |
| | | | isopropyl alcohol |
| Encapsulated | 1% Dry Powder | 0.1%-20% | PMU capsules, |
| Fragrances in | (of actual capsules) | | Gelatin capsules |
| combination | This equals a total | | Particle size: |
| with odor | of .70% of actual | | 10 μm-200 μm |
| removing | fragrance (70% | | Product form: |
| chemistry | loading levels in | | cake, slurry, dry |
| or singly | the capsules) | | podwer, etc. |
| Encapsulated | 0.2% of actual | 0.01%-2% | Tricolsan |
| Antimicrobial | capsules | | |
| agents | | | |
| Binder | 1% | 0.1%-10% | PVP/VA, PVP, |
| | | | cellulose |
| | | | thickeners, starch |
| Propellant | 70% | 30%-90% | Hydrocarbon, |
| (aerosol form) | | | nitrogen, CO₂ |

Carpeting and Other Non-woven Applications

| | | | |
|---|---|---|---|
| Water | 95.3% | 80%-99% | Water, Deionized |
| | | | water, |
| Encapsulated | 4% Slurry | 1%-10% | PMU capsules, |
| Fragrances | (this equals .84% | | Gelatin capsules |
| | of actual fragrance | | Particle size: |
| | when in the | | 10 μm-200 μm |
| | slurry form) | | Product form: |
| | (see below) | | cake, slurry, dry |
| | | | powder, etc. |
| Encapsulated | 0.2% | 0.01%-5% | Triclosan |
| Antibacterial | | | |
| Binder | 0.5% | 0.1%-5% | PVP/VA, PVP, |
| | | | Cellulose |
| | | | thickeners, starch |
| Solvent | 0% | 1%-20% | Isopropyl |
| | | | Alcohol, |
| | | | n-propanol, |
| | | | Ethanol |

For the encapsulated agents, the loading levels are 70% of actual encapsulated ingredient into the capsule. The slurry is 30% solids, cake is 90% solids, and powder is 100% capsules. For example:

4% slurry=1.2% capsules (4%*0.30)=0.84% fragrance (1.2*0.70).

1% Powder=1% capsules=0.70% fragrance (1*0.70).

The micro-capsules of the present invention (whether in slurry, powder, or any other form) may be delivered to target materials using a wide range of delivery systems. Exemplary delivery systems that may be used with the present invention include the following commercially available systems.

Trigger Sprayer: Calmar TS800, Calmar Mixor HP, Calmar Mixor MP

Pump Sprayers: Calmar Sprayette IV, Calmar SSA pump sprayer

Aerosol: Available from Precision Valve (Yonkers, N.Y.)

Upon application of the micro-capsules, the micro-capsules attach and imbed themselves within the interstices of the fabric or other structures upon which they are applied. The micro-capsules lie dormant until disturbed. When the treated material is perturbed, sufficient capsules are ruptured and broken to provide an effusive and pleasant scent to environment.

The present invention is not to be limited in scope by the specific embodiments described which are intended as single illustrations of individual aspects of the invention, and any copolymers, binders, and other agents disclosed herein which are functionally equivalent are within the scope of this invention. Indeed, various modifications of the invention in addition to those shown and described herein will become apparent to those skilled in the art from the foregoing description and accompanying drawings. Such modifications are intended to fall within the scope of the appended claims.

We claim:

1. An extended release fragrance composition comprising a fragrance, an anti-microbial agent and an odor-neutralizing component, wherein one or more of said fragrance, said anti-microbial agent, and said odor-neutralizing component is contained in a micro-capsule.

2. The composition of claim 1, wherein said micro-capsule is composed of a poly-oxymethylene cross-linked structure.

3. The composition of claim 1, further comprising a binding agent configured to bind said micro-capsule to a material.

4. A composition comprising a fabric surface bound by the composition of claim 1.

5. The composition of claim 4, wherein said fabric surface comprises carpet.

6. A composition comprising a paper material bound by the composition of claim 1.

7. The composition of claim 1, wherein said micro-capsule is configured to rupture upon exposure to compression force, heat, or shear force.

8. An extended release fragrance composition comprising a micro-capsule containing a fragrance, wherein said micro-capsule is configured to rupture upon exposure to compression force, heat, or shear force.

9. The composition of claim 8, wherein said micro-capsule is composed of a poly-oxymethylene cross-linked structure.

10. The composition of claim 8, further comprising an anti-microbial agent.

11. The composition of claim 8, further comprising a binding agent configured to bind said micro-capsule to a fabric surface.

12. The composition of claim 8, further comprising an odor neutralizing component.

13. A composition comprising a fabric surface bound by the composition of claim 8.

14. The composition of claim 13, wherein said fabric surface comprises carpet.

15. A composition comprising a paper material bound by the composition of claim 8.

16. A method of treating a material, comprising the step of exposing said material to the composition of claim 1 under conditions such that said composition binds to said material.

17. The method of claim 16, wherein said material comprises fabric.

18. The method of claim 16, wherein said material comprises paper.
